(19) United States
(12) Patent Application Publication
(10) Pub. No.: US 2017/0067502 A1
(43) Pub. Date: Mar. 9, 2017

(54) Pocket Hole Screw With Guide Bushing

(71) Applicant: Frank Marusiak, Annandale, NJ (US)

(72) Inventor: Frank Marusiak, Annandale, NJ (US)

(21) Appl. No.: 14/846,504

(22) Filed: Sep. 4, 2015

(51) Int. Cl. F16B 43/00; F16B 25/00

(52) U.S. Cl. CPC F16B 43/00; F16B 25/0015

(57) ABSTRACT

A improved pocket hole screw which includes a temporarily fixed guide bushing of essentially equivalent diameter to the screw head purposely providing properly spaced bearing support assuring centerline alignment as the screw enters a pocket hole. The guide bushing is located on the shaft of the screw and spaced apart from the screw head a distance relative to the screw length. The outer perimeter surfaces of the bushing and the screw head cooperate to maintain proper screw tip alignment within the center of the pocket hole assuring reliable and accurate entry of the screw tip into a smaller pilot hole at the bottom of the pocket hole. During final assembly of a pocket hole joint, upon driving the screw into the adjoining material the bushing is forced along the shaft towards the screw head and is tightened between the material at the bottom of the pocket hole and the underside of the screw head.

### CROSS REFERENCE TO RELATED APPLICATIONS

This application claims the benefit of provisional patent application Ser. No. 62/070,889 filed Sep. 9, 2014 by the present inventor.

### FEDERALLY SPONSORED RESEARCH

Not Applicable

### SEQUENCE LISTING OR PROGRAM

Not Applicable

### BACKGROUND—FIELD

This application relates to fasteners, particularly screws with guide bushings, more precisely pocket hole wood screws with guide bushings.

### BACKGROUND

Acceptance and popularity of Pocket Hole Joinery has grown rapidly due to this technologies joint strength and simplicity. Recently a new pocket hole technology was introduced at the 2014 International Woodworking Fair by CASTLE INC. ® This new technology introduced Model CSI-1.5, a pocket hole machine which like others automatically bored pocket holes however, this unique machine also simultaneously inserted the pocket hole screws yielding a ready to assemble workpiece upon removal from the machine. This feature was so well received it won a prestigious Challenger Award at the 2014 IWF. Unfortunately a $55,000.00 price tag leave this new machine and it's award winning screw insertion feature out of reach for all but the largest manufacturers. Clearly an affordable alternative is needed, such an alternative is disclosed herein.

Both machinery and manual jigs produce pocket holes. Many different automated and manual pocket hole jigs are available and while they may have different designs they all have one thing in common, they all use pocket hole screws. It is the pocket hole screw which this applicant has improved.

Disclosed herein is an improved pocket hole screw 100 which includes a guide bushing 103. This bushing 103 in cooperation with the screw head 101 encourage the screw tip 104 to reliably and accurately center upon entering a pilot hole 202 portion of a pocket hole 201 thereby allowing the screw to be properly inserted into the workpiece prior to removal from the jig. As such, upon removal from the drilling jig the pocketed workpiece will provide “Screw in Pocket”, “Ready to Assemble” benefits like the end product produced by the aforementioned award winning $55,000.00 pocket hole machine. As unexpected and unlikely as it may seem the present invention can provide similar benefits for merely the cost of a screw.

### PRIOR ART

Well known in the art are nails which include guide bushings. Such nails are used in powder actuated tools for example HILTI® model DXE72 nail gun. The purpose of the nail bushing is to center the nail within the bore of the gun barrel so that when fired it exits the gun properly. While such nails exist this applicant has found no prior art pocket hole screw with a guide bushing. Applicant has researched industrial suppliers McMaster Carr, MSN and Grainger as well as online suppliers and found no prior art which disclose a pocket hole screw with a guide bushing. There is also a large volume of prior art screws made using for example “RE-HEADER’ and/or “SEMS” type production wherein a washer or multiple washers and/or parts are assembled or formed together during high speed mass production. One such example is a disclosure by JAMES M. GALLIEN of an ornamental design for a Double headed self-tapping screw in U.S. Pat. No. D567,074 S1. GALLIEN makes no claim or disclosure as to the screws function. A “SEMS” type prior art screw is disclosed by STANAITIS, PETER P in U.S. Pat. No. 3,862,458(A) therein STANAITIS shows a threaded screw terminal for electrical connections having at least two washers carried upon an upper portion of the screw shank. During use thereof a wire or spade connector is inserted between the washers and is held therein when the screw is tightened. Another prior art screw is disclosed by FISHER CHARLES K; ARIAS, PIERRE E in U.S. Pat. No. 4,300,866 (A). FISHER CHARLES K; ARIAS, PIERRE reveal a Self-retaining spring washer positioned firmly in place upon the screw prior to use. There is enormous volume of prior art screws disclosing washers, lock washers, springs etc.; however applicant has found no prior art screw which uses a forcibly movable washer or more precisely a forcibly movable “BUSHING” as a guide to properly align a pocket hole screw within a pocket hole thereby providing reliable blind insertion of the screw tip into the pilot hole located at the bottom of a pocket hole. The present disclosure of a “guide bushing” provides a new use beyond the typical use of a basic washer which is normally used to simply distribute the load of a threaded fastener. Thus providing not merely a washer but a temporarily fixed and forcibly movable “Guide Bushing” provides novel benefit. Applicant respectfully submits this novel, new use pocket hole screw with a guide bushing has never been appreciated.

### SUMMARY OF THE INVENTION

Accordingly one object of the present invention is to provide an extremely simple and inexpensive improved pocket hole screw 100 which facilitates a workers ability to accurately and reliably insert pocket hole screws through the bore of a manual pocket hole jig and into the pilot hole 202. The end product workpiece can thereby be produced ready for assembly with “Screw in Pocket” prior to removal from the jig. The “Screw in Pocket” benefit has indeed been acknowledged at the 2014 IWF. Further, the improved pocket hole screw 100 will likewise facilitate accurate and reliable alignment and insertion of the screw tip 104 into the pilot hole 202 whether the user first removes the material from the jig or not. Consistently centered screw positioning reduces potential workpiece damage caused by misalignment of screw tip 104 and pilot hole 202.

### BRIEF DESCRIPTION OF THE DRAWINGS

FIG. 1 shows a prior art pocket hole screw and a prior art nail with bushing used in powder actuated tools;

FIG. 1a shows a prior art pocket hole screw and a partial cross-section view of a pocket hole jig including a view showing the prior art pocket hole screw entering the bore off the optimum center-line of the pilot hole; thereby illustrating misalignment relative to the screw tip and pilot hole;

FIG. 2 shows an improved pocket hole screw with guide bushing and a partial cross-section view of a pocket hole jig holding material, including a view showing the improved pocket hole screw with guide bushing entering the bore aligned with the optimum center-line of the pilot bore;

FIG. 2a is an enlarged view of the screw portion of FIG. 2 more clearly indicating how the guide bushing travels relative to the screw as would occur when inserted into a workpiece;

FIG. 2b shows a popular type of drilling jig with material clamped in place indicating the proper center-line travel of an improved pocket hole screw;

FIG. 3 is a full view of the pocket hole jig shown in partial section in FIGS. 1 and 2;

FIGS. 4, 5, 6 all show the same partial cross-section view of a pocket hole jig with clamp and material. Each drawing shows a particular step in the pocket hole process as it relates to the present invention;

FIG. 5a is an enlarged partial cross-section view of FIG. 5 showing the improved pocket hole screw seated within the pocket hole;

FIGS. 7 and 8 show a cross-section view of final assembly as it relates to the present Invention;

FIG. 9 is a side view of a preferred embodiment including an enlarged close-up view showing the common connection point of bushing and shaft;

FIG. 10 shows a series of 6 drawings depicting a “T” shaped collapsible bushing located upon a pocket hole screw;

### DETAILED DESCRIPTION OF THE INVENTION

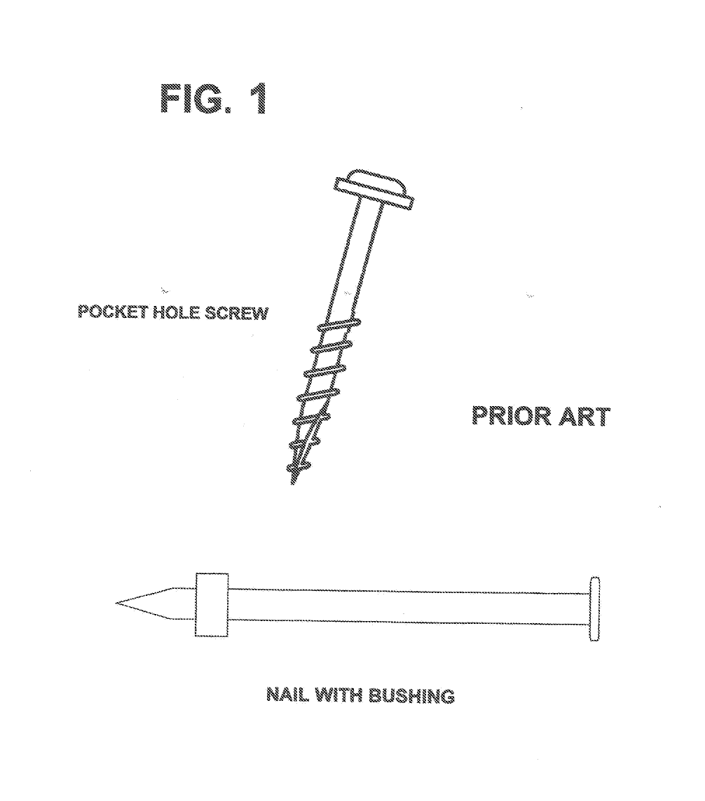

Referring now to Prior Art FIG. 1: Shown is a typical pocket hole screw well known in the art. Also shown is a known nail with a guide bushing used in powder-actuated tools such as HILTI® model DXE72. This type of nail or pin as it is sometimes called includes a bushing which acts to center the nail within the barrel of a powder-actuated tool (gun) so that the nail properly exits the gun barrel upon firing. These type nails with bushings come in different styles and bushing materials based on each manufacturers requirements. Typically the bushings are located near the point of the nail so as to better align the nails length within the barrel of the nail gun. The bushing is destroyed upon firing as it has no further purpose. Applicant has found no prior art which discloses screws with guide bushings or more particularly pocket hole screws with guide bushings as disclosed herein. Applicant suspects screws with guide bushings have not been previously disclosed as they may not have any real value or purpose. Applicant respectfully submits this novel, new use of a guide bushing upon a pocket hole screw clearly has value and purpose but has never been recognized, thus never appreciated.

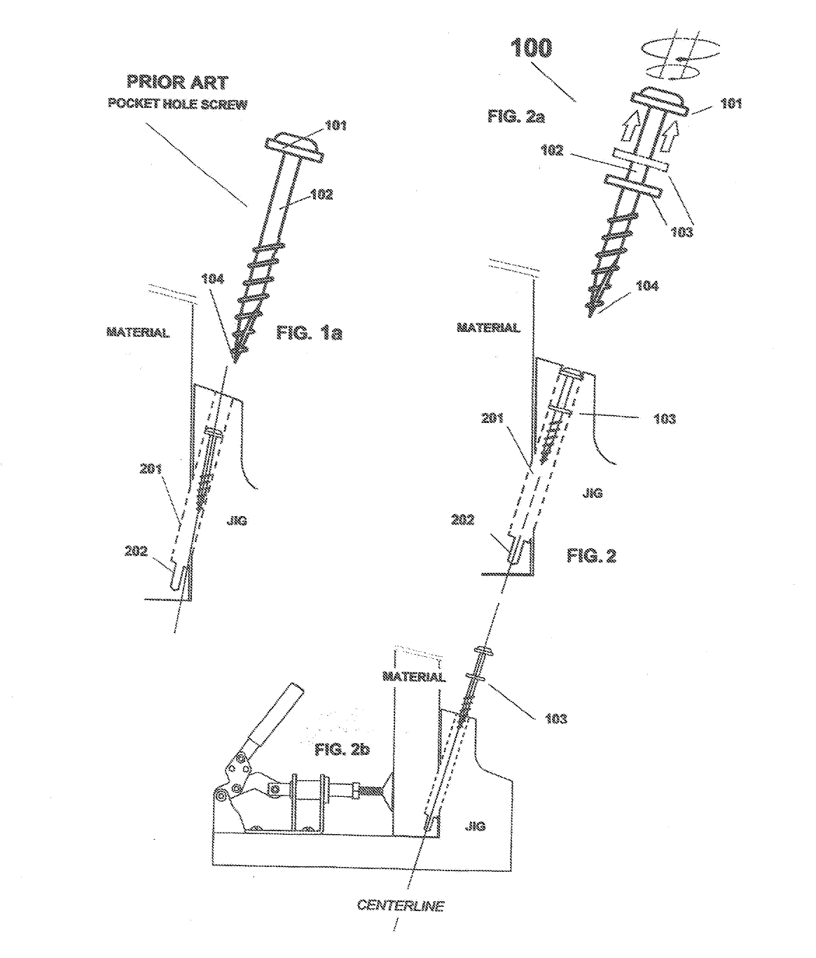

In further detail, referring now to prior art FIG. 1a; shown is a prior art pocket hole screw and a partial cross-section view of a pocket hole jig holding material. This cross-section view shows a prior art pocket hole screw entering the bore of the jig on its travel down into the drilled pocket hole 201. Due to the narrow diameter of the screw shaft 102 and screw tip 104 compared to the larger diameter pocket hole 201 the prior art pocket hole screw lacks any bearing surface within the pocket hole 201 beyond the screw head 101. Subsequently the prior art pocket hole screw tends to enter the pocket hole 201 with the narrower screw tip 104 misaligned relative to the center-line of the pilot hole 202. As such it cannot reliably align with and properly enter the smaller diameter pilot hole 202 at the base of the pocket hole 201. Therefore the material cannot be reliably and/or consistently removed from the drilling jig with the prior art pocket hole screw properly inserted and secured within the pilot hole 202 so as to be in the ready to assemble position within the material upon removal from the jig. FIG. 2 shows the same partial cross-section view of a pocket hole jig holding material. This cross-section view shows an improved pocket hole screw 100 entering the bore of the jig on its travel down into the drilled pocket hole 201. The enlarged illustration shown in FIG. 2a illustrates an improved pocket hole screw 100 with guide bushing 103 positioned about the screw shaft 102. Further detail indicates movement of the guide bushing 103 towards the underside of the screw head 101. This movement occurs only as the improved pocket hole screw 100 is driven into an adjoining workpiece during assembly. As shown in FIG. 2 the guide bushing 103 provides an additional bearing surface along with screw head 100b as it is inserted through the jig and into the pocket hole 201. This encourages reliable and consistent alignment of the screw tip 104 into pilot hole 202. This reliable positioning allows the material to be removed from the drilling jig with the improved pocket hole screw 100 properly positioned within the pocket hole 201. Since the thread diameter of a pocket hole screw is slightly larger than the pilot hole 202 this purposeful fit secures the improved pocket hole screw 100 within the pilot hole 202 upon removal from the jig.

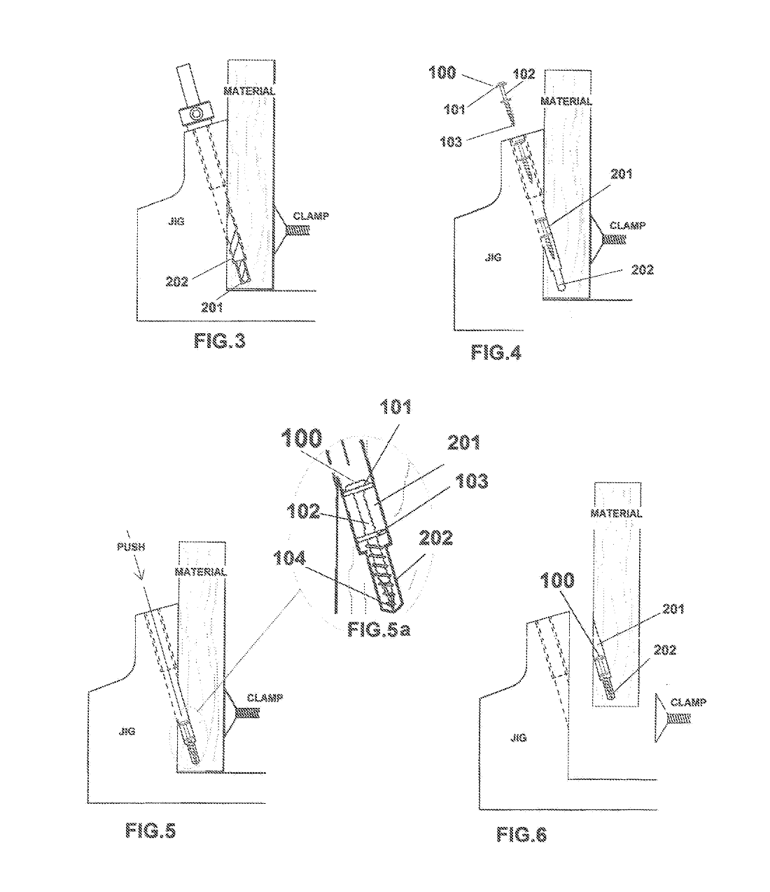

Consequently the workpiece is ready for assembly with an adjoining workpiece. FIG. 2b shows a more detailed illustration of a popular type of drilling jig with material clamped in place. This illustration also indicates the proper center-line travel of an improved pocket hole screw 100 of the present invention. FIGS. 3, 4, 5 and 6 all show the same partial cross-section view of a pocket hole jig with clamp and material. Each drawing shows a particular step as it relates to the present invention; the typical sequence is explained as follows:

FIG. 3 material is clamped within a pocket hole drilling jig and a pocket hole is drilled to a known depth relative to material thickness and screw length. As shown in FIG. 4 the improved pocket hole screw 100 is inserted into the jig hole and it will typically drop into pocket hole 201. FIG. 5 indicates the next simple step in the sequence. Using any item of sufficient length that fits into the pocket hole 201 for example a screwdriver the improved pocket hole screw 100 is pushed into the pocket hole 201. Upon pushing the screw tip 104 is blindly encouraged into the pilot hole 202 as a result of proper alignment provided by the improved pocket hole screw 100 of the present invention. FIG. 5a is an enlarged cross-section view indicating how the improved pocket hole screw 100 would properly seat within the pocket hole 201 and the pilot hole 202. FIG. 6 shows the material being unclamped and removed from the drilling jig. The slightly tight fit between the screw thread diameter and the pilot hole 202 cause the improved pocket hole screw 100 to remain secure within the pocket hole upon removal from the jig. This purposeful fit which is typical relative to pocket holes and pocket hole screws permits hassle free removal and handling of the screw loaded workpiece upon removal from the jig. The pocketed workpiece is now ready for assembly with screws already loaded within the workpiece like the award winning end product of the $55,000.00 pocket hole machine.

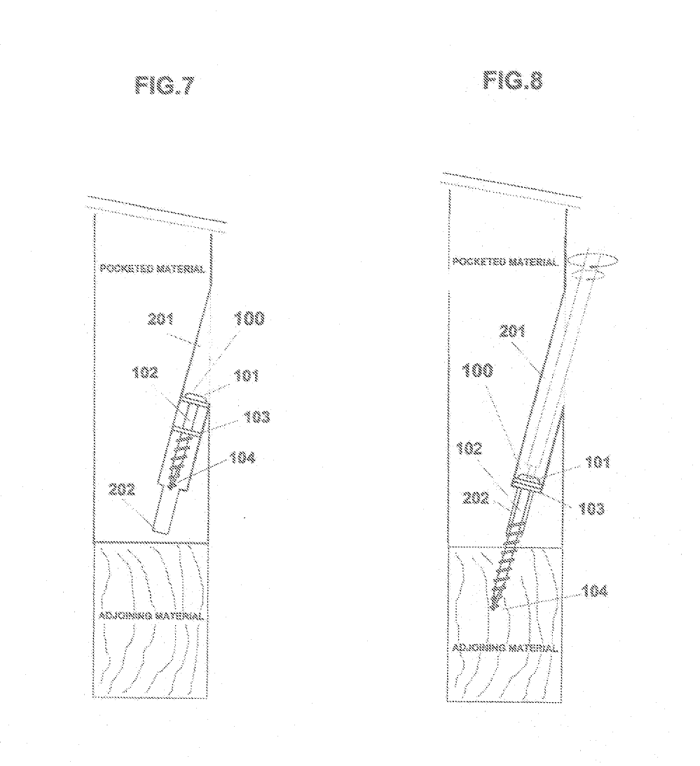

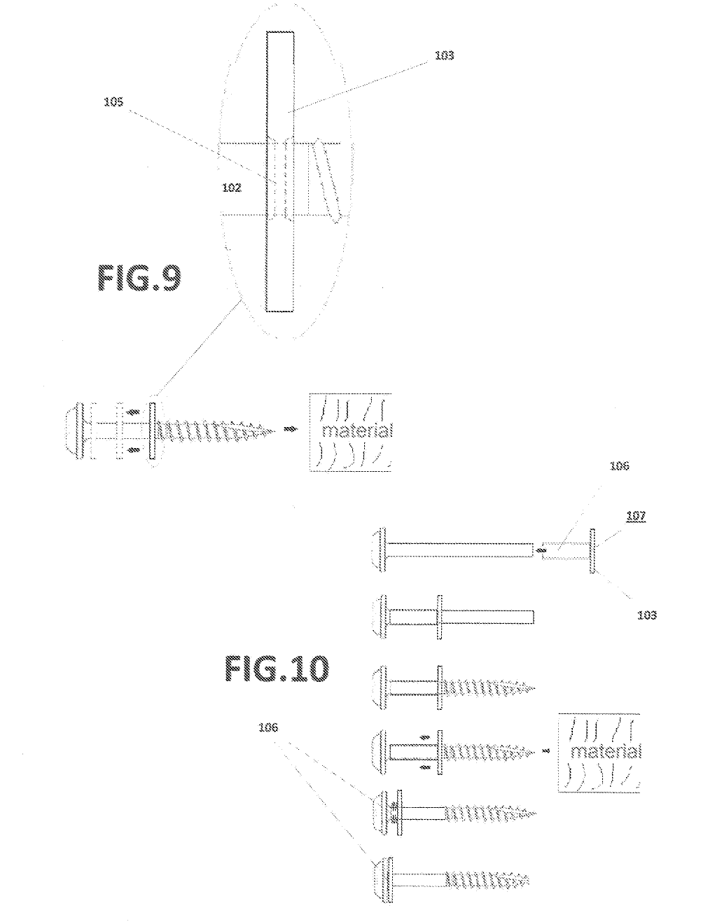

FIG. 7 shows a clear cross-section view of how an improved pocket hole screw 100 seats within a pocket hole prior to final assembly. Viewed side by side FIG. 7 along with FIG. 8 clearly indicate just how simple the improved pocket hole screw 100 with guide bushing 103 works. In FIG. 8 one can see that guide bushing 103 and screw head 101 remain intact and spaced apart prior to improved pocket hole screw 100 being screwed into the adjoining material. As indicated in FIG. 8 upon driving the screw into the adjoining material the guide bushing 103 separates from the screw shaft 102 and is slid along the screw shaft 102 towards the bottom of the screw head 101 where it becomes tightened between the material at the bottom of the pocket hole 201 and the underside of the screw head 101 completing the pocket joint assembly. FIG. 9 shows a preferred embodiment of the improved pocket hole screw 100 with guide bushing 103. This embodiment provides an improved pocket hole screw 100 with guide bushing 103 formed as one piece with a “break-away” common connection point 105. The section of improved pocket hole screw 100 with guide bushing 103 which includes “break-away” common connection point 105 is shown in close up view. The material at “break-away” common connection point 105 is thin enough to allow it to separate from the screw shaft 102 upon driving improved pocket hole screw 100 into a workpiece but strong enough to resist separation prior to driving improved pocket hole screw 100 home. FIG. 10 shows an alternate embodiment as a series of 6 drawings depicting a one piece “T” shaped bushing 107 located upon the screw shaft 102. “T” shaped bushing 107 includes collapsible cylinder portion 106 which is designed with wall thickness thick enough to properly locate and support the guide bushing 103 upon screw shaft 102 but thin enough to easily compress upon driving pressure.

DRAWINGS-REFERENCE NUMERAL

100-improved pocket hole screw
101-screw head
102-screw shaft
103-guide bushing
104-screw tip
105-common breakaway connection point
106-collapsible cylinder portion
107-T shaped bushing
201-pocket hole
202-pilot hole

Advantages of Invention

The present invention is designed to provide small shops, schools, DIY's benefits of “Screw in Pocket” “Ready to Assemble” technology. By inserting the improved pocket hole screw 100 with guide bushing 103 into the jig bore prior to removal of the workpiece, such benefit can be realized. As such upon removal from the jig the workpiece is “Ready to Assemble” like the end product provided by the award winning CASTLE INC.® CSI-1.5. Another equally significant advantage provided by the present invention is that if a worker chooses to simply insert the improved pocket hole screw 100 with guide bushing 103 into the pocket hole 201 without using the drill jig as described above the improved pocket hole screw 100 with guide bushing 103 will passively and positively provide consistent, reliable and accurate non-visual placement of the screw tip 104 within the pilot hole 102, thereby eliminating potential workpiece damage resulting from misaligned screw entry during joint assembly.

I claim:

1) An improved screw used for pocket hole joinery, the screw comprising:
a) a top portion forming a head
b a cylindrical portion extending below the head forming a shaft
d) the shaft having a threaded portion
e) a guide bushing temporarily fixed around said shaft
f) said guide bushing fixed a predetermined distance below said head
g) said guide bushing having at least the same outside diameter as said head
h) said guide bushing having minimal thickness
i) said guide bushing forcibly movable towards said head during threaded insertion of said screw
whereby perimeter of said guide bushing cooperates with perimeter of said head to center said screw within a pocket hole thereby providing proper alignment during insertion thereto.

2) The guide bushing of claim 1 wherein said guide bushing is formed as an integral breakaway part of said improved screw.

3) The guide bushing of claim 1 wherein said guide bushing is a separate part assembled and retained onto said screw.

4) The guide bushing of claim 1 wherein said guide bushing is a separate collapsible “T” shaped bushing assembled and retained onto said screw.
